(19) United States
(12) Patent Application Publication
(10) Pub. No.: US 2012/0213283 A1
(43) Pub. Date: Aug. 23, 2012

(54) METHOD OF DECODING A SEQUENCE OF ENCODED DIGITAL IMAGES

(75) Inventors: Naël OUEDRAOGO, Maure de Bretagne (FR); Herve LE FLOCH, Rennes (FR)

(73) Assignee: CANON KABUSHIKI KAISHA, Tokyo (JP)

(21) Appl. No.: 13/401,628

(22) Filed: Feb. 21, 2012

(30) Foreign Application Priority Data
Feb. 23, 2011 (GB) 1103079.8

(51) Int. Cl. H04N 7/32

(52) U.S. Cl. 375/240.16; 375/240.12; 375/E07.243; 375/E07.123

(57) ABSTRACT

The disclosure provides a method of decoding a sequence of encoded digital frames encoded by an encoder using a format applying block-based prediction. For the decoding of an encoded digital frame which comprises a missing area, the method includes obtaining additional data associated with at least one block of the encoded digital frame. Using the obtained additional data, for at least one block of the missing area, information identifying one type of predictor in a predetermined list of types of predictor is obtained. A reconstruction method for the at least one block of the missing area is selected using the information identifying one type of predictor.

### CROSS REFERENCE TO RELATED APPLICATIONS

The present application claims priority from Great Britain Patent Application No. 1103079.8, filed Feb. 23, 2011, which is hereby incorporated by reference herein in its entirety.

### BACKGROUND OF THE INVENTION

1. Field of the Invention

The present invention relates to a method of decoding a sequence of encoded digital images with error correction, to an associated encoding method, as well as to associated devices. It relates to the field of the transmission of multimedia data over a communication network such as an Internet Protocol (IP) network. It applies in particular, but not only, to the correction of errors introduced during the transmission of video data compressed with motion compensation, and has particular advantages for multimedia streaming.

2. Description of the Related Art

In current video transmission systems, many videos are coded using motion compensation compression algorithms that reduce the amount of data to transmit. Different standards are used (for example MPEG2, MPEG4 part 2, H.264/AVC), which are all based on the coding of differences between successive images.

A video bitstream encoded with such a format is highly sensitive to transmission errors occurring between the server and the client. Such errors result in incorrectly decoded visual information that may propagate in images following the incorrectly decoded image over a long period of time.

A conventional method to correct transmission errors is to have the client signal the error to the server and the server perform a retransmission of data. This method is used in TCP/IP protocol. But such a method cannot always be used, for example when there is no feedback channel, which is the case in broadcast video transmissions, or in case too many clients make requests. It is not possible either if the timing constraints are too strict given the network latency, such a situation being frequent for example in long distance video conferences.

Another conventional method which can be used to correct transmission errors is so-called Forward Error Correction (FEC). An error correction code is computed on the basis of the compressed video bitstream. It is then transmitted with the bitstream.

In such methods, the server anticipates the maximum error rate in order to correctly choose the size of the error correction code, given the available bandwidth of the network. If the size of the error correction code becomes too great, the video has to be highly compressed and the quality thus becomes low. On the other hand, if the error correction code size is too small for the real error rate, no error is corrected.

Thus all errors are corrected until a maximum error rate is reached, such rate depending on the bandwidth. When this rate is reached, even if the server has good anticipation capabilities, the error correction code no longer works and the quality becomes suddenly bad. It would be advantageous to have a system with progressive quality degradation.

Another method of error correction is known as “error concealment” (EC). It is referred to as a reconstruction method. It consists in hiding errors at the video decoder by computing temporal or spatial interpolations in the images. This method has the advantage of providing the viewer with progressive quality degradation when the error rate increases. It generally provides a good visual quality, but depending on the video content it sometimes fails in areas of the images, introducing visual artefacts which propagate and give a bad visual experience to the viewer.

Different error concealment algorithms give different results with a quality that depends on the video content. However, there is no universal error concealment algorithm which always gives a good result.

### SUMMARY OF THE INVENTION

Error concealment is generally used in addition to retransmission and/or FEC code in order to mask errors when retransmission or FEC codes fail. Using the best error concealment method for each block of the frame is also key to obtaining a good video quality, but is difficult to achieve.

In this context, an object of the invention is to improve the quality of a video sequence in case of packet loss by selecting a reconstruction method, in particular, an error concealment algorithm, adapted for each block of the sequence.

The problem solved by the invention is the improvement of the error correction capabilities of the decoder, and more specifically the design of a method enabling the decoder to select from among several available error concealment algorithms the algorithm that is the most adapted for each incorrect block of a frame.

The invention uses the computation of additional data by the server and its transmission to the client. This information is additional to the information defining the coded blocks using the standard.

In the invention, such additional data is used by the client to determine which error concealment algorithm or reconstruction method is optimal among a set of possible, error concealment algorithms, for each missing block of a frame. Erroneous blocks may be considered, and preferably are considered as being missing blocks.

In order to be competitive with conventional methods such as error correction codes that also send additional data with the bitstream, the bit rate of this additional data needs to be low. The method of the invention uses one index (integer) for each block, identifying one item in a predefined static list. Such information has the advantage of being very small in quantity.

The document U.S. Pat. No. 7,324,698 describes a method for error-resilient encoding, using the transmission of auxiliary data over the network, but the quantity of the transmitted auxiliary data is high.

The invention uses the fact that several block prediction schemes, or block prediction modes are known. These schemes or modes can be INTER (temporal) modes or INTRA (spatial) modes, in particular. They may differ, inter alia, by the way motion vectors of INTER coded blocks are predicted, or by the way the neighbouring blocks are used for the prediction of INTRA coded blocks. These modes or schemes are referred to as “types of predictor”.

An object of the invention is thus a method of decoding a sequence of encoded digital frames encoded by an encoder using a format applying block-based prediction, comprising, for the decoding of an encoded digital frame which comprises a missing area,
obtaining additional data associated with at least one block of said encoded digital frame,
obtaining, using said additional data, for at least one block of said missing area, information identifying one type of predictor, or at least one type of predictor, in a predetermined list of types of predictor,
selecting a reconstruction method for said at least one block using said information identifying one type of predictor.

This method allows selection of an adequate error concealment algorithm for each block of a missing area, and thus improves the visual rendering of the sequence. The additional data, typically transmitted by the encoder to the decoder via the network requires little bandwidth and little CPU of the client to be decoded.

According to a particular aspect of the invention, the step of selecting a reconstruction method for said at least one block includes a step of computing predicted information for at least one of the types of predictor of the predetermined list of types of predictor for said at least one block independently of said additional data and a step of obtaining one item of predicted information using the identified type of predictor.

The step of computing predicted information may include computing a predicted motion vector and/or computing a predicted block. In an embodiment, an item of predicted information is a predicted motion vector. In another embodiment, an item of predicted information is a predicted block.

According to a particular aspect of the invention, the step of selecting a reconstruction method for said at least one block includes a step of computing at least one candidate, or a set of one or more candidates for said at least one block independently of said additional data, each candidate being associated with a predefined reconstruction method. The candidates may be motion vectors and/or blocks.

According to an embodiment, the step of selecting a reconstruction method for said at least one block comprises selecting a candidate that is closer, according to a predetermined distance, to said item of predicted information computed for said at least one block using the identified type of predictor than to any other computed item of predicted information.

Advantageously, the identified type of predictor obtained from the additional data provided by the encoder helps selecting the reconstruction method which provides the best candidate for replacing the lost area.

According to a particular aspect of the invention, the step of selecting a reconstruction method for said at least one block includes a step of comparing, for example by computing a distance, such as the norm of a difference, of at least one item of predicted information computed for said at least one block using one of the predictors of the list and at least one candidate computed for said at least one block, said candidate being associated with a predefined reconstruction method,

For example, this latter step can be followed by a step of comparing said distance with the distance between said candidate and one item of predicted information computed for said at least one block using the identified type of predictor.

In an embodiment, the step of selecting a reconstruction method for said at least one block includes a step of computing the distance between each item of predicted information computed for said at least one block with the types of predictor of the list and each candidate computed for said at least one block.

The step of selecting a reconstruction method may further include comparing said distance or norm with a predetermined threshold.

According to a particular aspect of the invention, the step of selecting a reconstruction method for said at least one block includes selecting a reconstruction method associated with a particular candidate from a set of candidates if the particular candidate is the only candidate that has not been discarded during a preliminary assessment of all the candidates of the set.

According to an advantageous feature, the additional data comprises error correction information, and the step of obtaining information identifying a type of predictor in a predetermined list includes retrieving an index representative of the type of predictor by applying an error correction decoding using the additional data obtained.

Typically, the additional data obtained at the decoder may contain parity checks of an error correction code applied on the indexes representative of the type of predictor identified for the blocks of data. With this feature, the bit rate of data to be sent by the server is decreased.

Another object of the invention is a method of encoding a sequence of digital frames using a format applying block-based prediction, comprising, for the encoding of a digital frame,

obtaining, for at least one block of the frame, information identifying one type of predictor in a predetermined list of types of predictor or block prediction scheme,

encoding said information identifying one type of predictor as encoded additional data,

sending said encoded additional data over the network, said encoded additional data being associated with said at least one block of said digital frame.

Generally speaking, the step of obtaining, for at least one block of the frame, information identifying one type of predictor in a predetermined list of types of predictor or block prediction scheme includes comparing at least one item of predicted information predicted for the at least one block of the frame with at least one item of actual information related to the at least one block of the frame.

According to particular aspects of the invention, the step of obtaining for at least one block, information identifying one type of predictor includes comparing a predicted motion vector with the motion vector of the at least one block of the frame, or comparing a predicted motion vector with a motion vector that allows the minimization of distortion (i.e. difference) between a reference block and the at least one block of the frame, or comparing a predicted block with the at least one block of the frame.

Another object of the invention is a device for decoding a sequence of encoded digital images encoded by an encoder using a format applying block-based prediction and transmitted through a network, comprising, for the decoding of an encoded digital frame which comprises a missing area,

means for obtaining additional data from the network, said additional data being associated with at least one block of said encoded digital frame,

means for obtaining, using said additional data, for at least one block of said missing area, information identifying one type of predictor in a predetermined list of types of predictor or block prediction scheme,

wherein said information identifying one type of predictor is then used by a selection module in selecting a reconstruction method for said at least one block.

Another object of the invention is a device for encoding a sequence of digital images using a format applying block-based prediction, comprising, for the encoding of a digital frame,

means for obtaining, for at least one block of the frame, information identifying one type of predictor in a predetermined list of types of predictor or block prediction scheme

means for encoding said information identifying one type of predictor as coded additional data,

means for sending said coded additional data over the network, said encoded additional data being associated with at least one block of said digital frame.

Other objects of the invention are computer programs comprising a series of instructions adapted, when they are executed by a microprocessor, to implement a method of decoding or a method of encoding as presented herein.

### BRIEF DESCRIPTION OF THE DRAWINGS

The invention will be better understood by reference to the following description with the accompanying drawings, wherein

FIG. 1 shows an example of a data communication network in which embodiments of the invention can be implemented.

FIG. 2 illustrates a device adapted to incorporate one or more embodiments of the invention.

FIG. 3 illustrates important modules of a server and a client using one or more embodiments of the invention.

FIG. 4 illustrates additional data processing performed in the server according to an embodiment of the invention.

FIG. 5 illustrates additional data processing performed in the client according to an embodiment of the invention.

FIG. 6 shows the error concealment method of one embodiments of the invention.

FIG. 7 shows the error concealment method of a second embodiment of the invention.

FIG. 8 shows two consecutive frames of a motion compensated video sequence with some data loss.

### DESCRIPTION OF THE EMBODIMENTS

In the following, a detailed description of embodiments of the present invention will be given with reference to the accompanying drawings. The invention concerns a method of decoding a sequence of encoded digital frames encoded by an encoder using a format applying block-based prediction. The method of the invention comprises, for the decoding of an encoded digital frame which comprises a missing area, a first step of obtaining additional data associated with at least one block of said encoded digital frame. This step is followed by a step of obtaining using the additional data, for at least one block of said missing area, information identifying one type of predictor in a predetermined list of types of predictor. The information identifying one type of predictor is then used for the selection of a reconstruction method for said at least one block. This method advantageously allows a selection of an adequate reconstruction method for blocks of a missing area, and thus improves the visual rendering of the sequence. The additional data, typically transmitted by the encoder to the decoder via the network, requires little bandwidth.

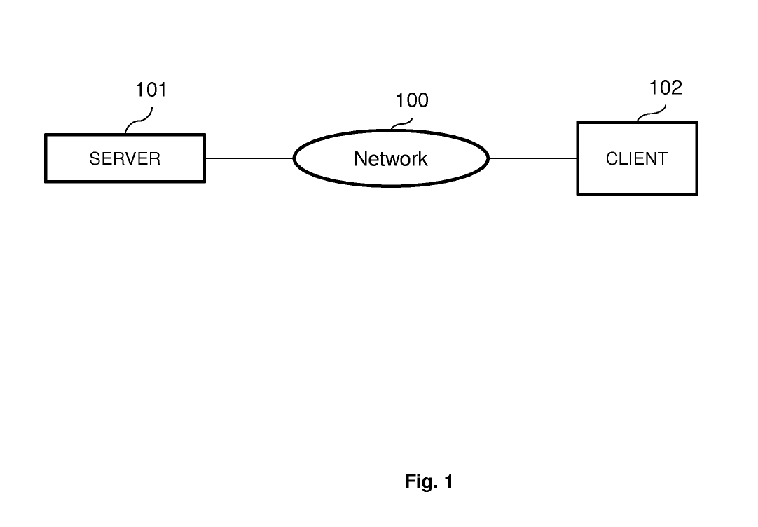

With reference to FIG. 1, a client-server system to which the invention may be applied is represented. A sending device or server 101 transmits data packets of a data stream to a receiving device or client 102 via a data communication network 100.

The data communication network 100 (WAN—Wide Area Network or LAN—Local Area Network) may for example be a wireless network (Wifi/802.11a or b or g), an Ethernet network, the Internet network or a mixed network composed of several different networks. The system can also be a digital television broadcast system. In this latter case, the server sends the same data to several clients.

The data stream provided by the server 101 is composed of multimedia information representing video and audio. The audio and video streams may be captured by the server 101 using a camera and a microphone. The streams may also be stored on the server or received by the server from another machine.

The video and audio streams are coded and compressed by the server 101. The compressed data is divided into packets and transmitted to the client 102 by the network 100 using a communication protocol that can be RTP (Real-time Transport Protocol), UDP (User Datagram Protocol) or any other type of communication protocol.

As is often the case, the rate available over the network 100 is limited, for example by the presence of competing data streams. Moreover, the transmission time and the rate of data loss from the server to the client may vary depending on the state of the network. Radio interference or congestion caused by competing streams may for example create delays in the transmissions or even cause packet losses and thus errors. Other causes of error also exist.

The client 102 decodes the data stream received through the network 100 and displays the video images on a screen and plays the audio data through a loud speaker. As explained in the preamble, the decoder tries to hide the errors using an error concealment algorithm.

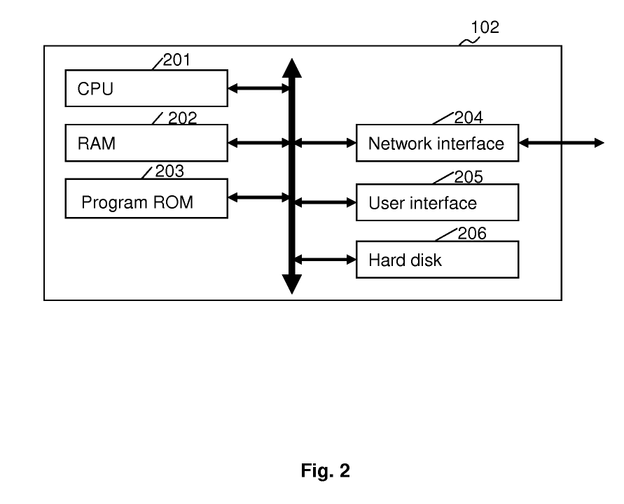

FIG. 2 is a block diagram of a client 102 adapted to incorporate the method of decoding of the invention. A server 101 adapted to incorporate the method of encoding of the invention could actually be represented by a similar block diagram.

Preferably, the device 101 or 102 comprises a central processing unit (CPU) 201 capable of executing instructions obtained from a program ROM (Read Only Memory) 203 on powering up and instructions relating to a software application obtained from another memory 202 shortly afterwards. The memory 202 is for example of the Random Access Memory (RAM) type which can be used as a working area of CPU 201, and the memory capacity thereof can be expanded by an optional RAM connected to an expansion port (not illustrated). Instructions relating to a software application may be loaded into the memory 202 from a hard-disk (HD) 206 or from the program ROM 203 for example. Such a software application, when executed by the CPU 201, causes the steps of the method of the invention to be performed on the device 101 or 102. In an example, a computer program may include a series of instructions adapted to implement an embodiment method in response to the series of instructions being executed by a microprocessor. In another example, a computer-readable storage medium may store a program that causes a device to perform a method described herein. In another example, a central processing unit (CPU) may be configured to control at least one unit utilized in a method or apparatus described herein.

Reference numeral 204 shows a network interface that allows the connection of the device 101 or 102 to the communication network 100.

Reference numeral 205 further shows a user interface adapted to display information to from a user and/or to receive inputs therefrom.

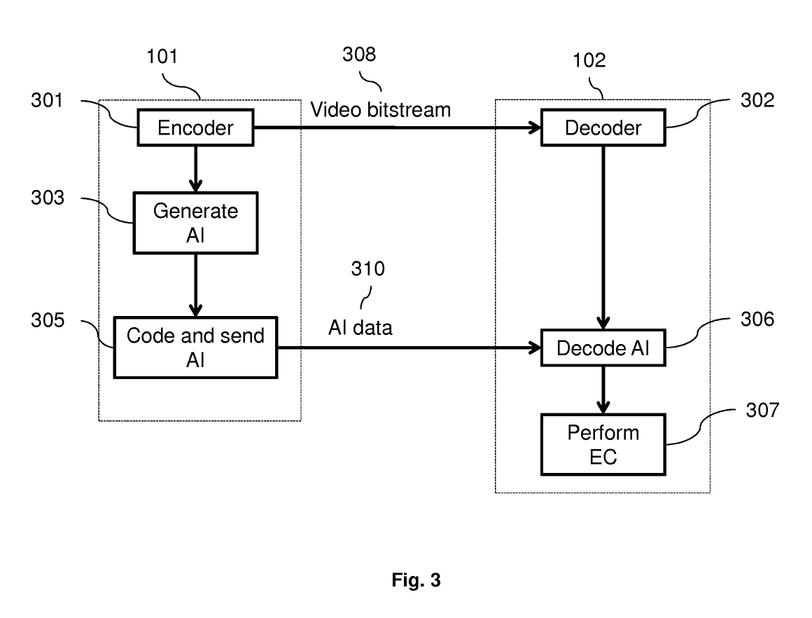

FIG. 3 shows main modules of the video server and client of the invention. In the server 101, video data is received by an encoder 301 in charge of compressing said data. Such video data can be compressed using a motion compensation format such as MPEG2, MPEG4 part 2 or H.264/AVC. The compressed video data is composed of independent units (NAL units or NALU for Network Abstraction Layer Units in H.264/AVC—or slices in MPEG4 part 2) each of which can be decoded independently and comprises particular blocks of pixels.

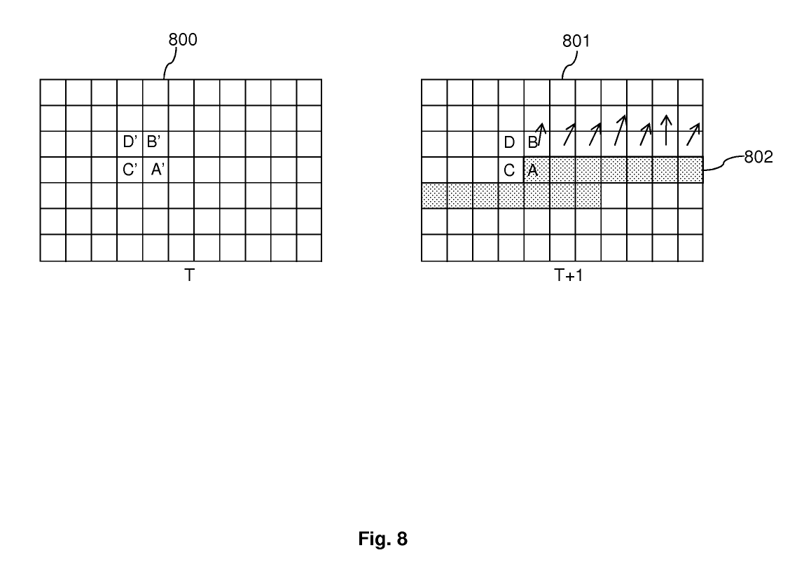

FIG. 8 shows two consecutive frames 800 and 801 of a video sequence compressed with a motion compensation format. Each frame is divided in blocks. The set of blocks of the area 802 is transmitted in a single slice or NAL unit.

Motion compensation formats generally have two main coding types available: INTER coding and INTRA coding.

A block can be coded in INTRA mode, in which case it is predicted on the basis of the neighbouring blocks in the frame. In H.264/AVC, nine such INTRA prediction methods are defined, each method using a different way of predicting the block on the basis of the neighbours, each way being associated with a direction called “prediction direction”. For instance, a prediction method known as “vertical prediction” consists in predicting each line of the block on the basis of the line of pixels located just above the block. Another method is known as “horizontal prediction” and consists in predicting each pixel of the block as being equal to the pixel located on the same line on the left boundary of the block.

In INTER prediction, each block is predicted from a reference block in a previously decoded frame (referred to as reference frame). Each block is thus represented by a vector and a residue. The vector, called motion vector, represents the translation between the reference block and the current block. The residue is the difference between the block calculated on the basis of the reference block and the vector, and the current block. For instance, a set of blocks encoded with INTER prediction has been represented in the frame 801 on FIG. 8. Their motion vectors are shown.

Generally, motion vectors are not directly coded in the bitstream but are firstly compressed. The compression process consists in predicting the motion vector of a block from those of its neighbours. Only the difference (MVD for Motion Vector Difference) between the predicted motion vector and the original motion vector is coded and introduced in the bitstream. As a result, the predicted motion vector requires fewer bits to be coded than the original motion vector.

The H.264/AVC norm specifies only one temporal prediction scheme or temporal type of predictor for the encoding of the motion vectors. This scheme uses as motion vector predictor for the current block the median of the motion vectors of the neighbouring blocks of the current block.

But new codecs offer more types of temporal predictor. For example, the motion vector of the collocated macroblock in the previous frame and the median motion vector of the neighbours of the current block are two types of predictors defining ways of predicting the motion vectors of the current block.

The resulting video bitstream 308 obtained at the end of the compression process is transmitted to the client. For example, the compressed video bitstream is decomposed in packets which are sent in RTP packets on UDP.

During the transmission, errors may occur causing packet losses. Bit errors can be detected by an error detection code and packets containing errors can be considered as lost.

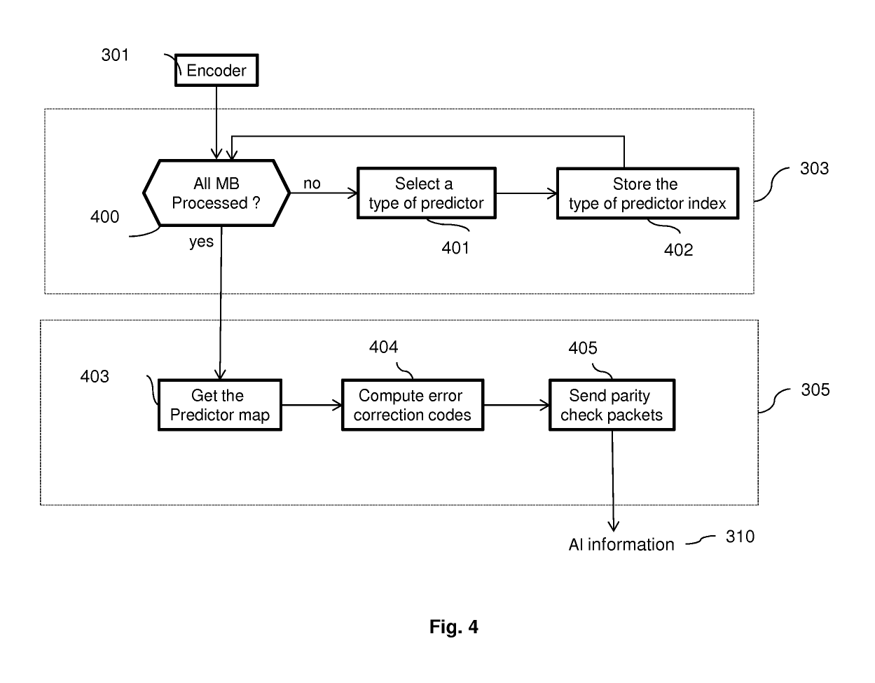

In the invention, additional data is created in the generation module 303 by using the predictor information of each block. The generation of additional data is described in detail in relation with FIG. 4.

Additional data computed by the generator module 303 is coded and packetized for transmission in module 305. In an embodiment, it is transmitted in a separate RTP stream, different from the video stream 308. In another embodiment (not shown), the additional data is embedded inside the video bitstream using for example SEI (acronym of Supplemental Enhancement Information, designating a bitstream unit reserved for information) extensions in the H.264 video format. In this second embodiment, the two streams 308 and 310 are merged.

The client 102 receives the video bitstream 308 and the additional data bitstream 310. The video is then decoded by the decoder 302. The decoder 302 then provides partially decoded images to the decoder of additional data 306. When the bitstream is correctly received, it is possible not to use this module 306 and the subsequent error concealment module 307.

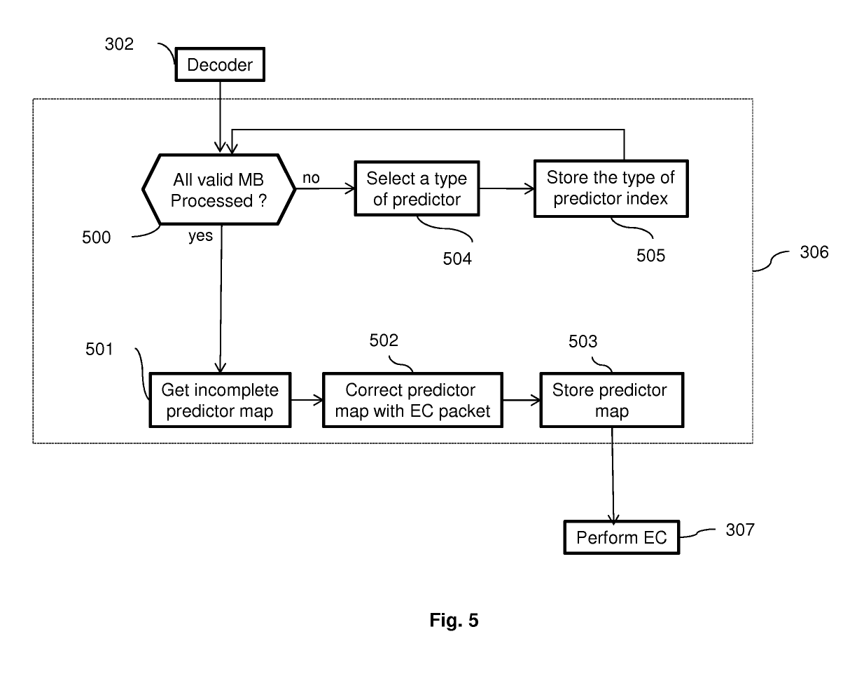

Additional data is decoded by module 306, in a process detailed in relation with FIG. 5. The additional data obtained at the output of the decoding module 306 is the same as the one obtained at the output of the generator module 303.

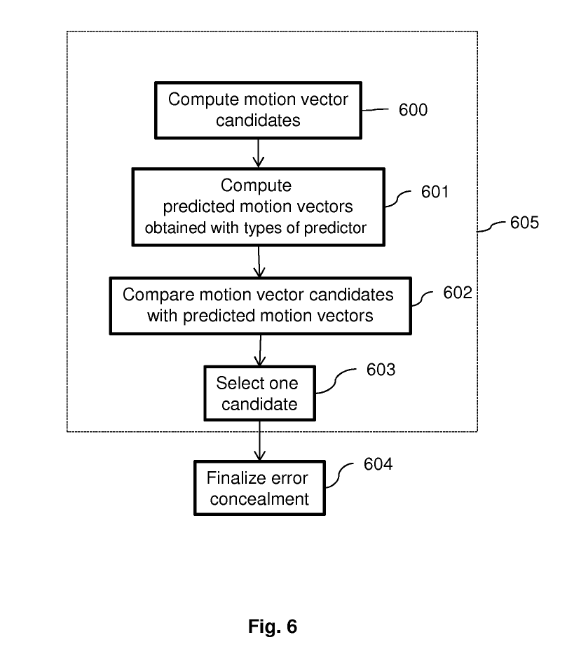

An error concealment method is then selected based on the additional data. This step is described in relation with FIG. 6.

The result of additional data generation is a set of indexes which are integer values, each index of the set identifying a type of predictor for one block. This set of indexes is referred to as a predictor map, each item of the map being associated with one block.

FIG. 4 illustrates the generation and coding process of the predictor map in the server 101. The generation process of the predictor map is initiated after each operation of encoding a frame. It uses a static list of block prediction schemes or block prediction modes, referred to, as already mentioned, as a list of types of predictor. This list is pre-determined and is identically defined for the server 101 and the client 102.

In an embodiment of the invention, the number of types of predictor of the list is equal to 2. Each of the types of predictor of the list is a temporal type of predictor.

In this embodiment, the first type of predictor in the list (for example, predictor of index 0) is a temporal prediction scheme using the motion vector of the collocated block of the previous frame as the motion vector for the current block. In FIG. 8 the collocated block of the block A of frame 801 is the bloc A′ of the preceding frame 800. Thus, using the first type of predictor of the list to predict block A implies predicting the motion vector of block A with the one of block A′.

The second type of predictor in the list (for example, predictor of index 1) is an INTER prediction scheme using the median vector of the neighbours of the collocated block in the previous frame as the motion vector predictor of the current block. In FIG. 8 the neighbours of the collocated block of block A are blocks B′, C′ and D′. Thus using the second type of predictor of the list to predict block A implies predicting the motion vector of block A with a motion vector equal to the median vector of the motion vectors of blocks B′, C′ and D′.

However, the number of types of predictor is not limited and could be any integer superior or equal to 2.

The steps 401 and 402 of FIG. 4 are successively applied to each block of the frame to determine the index of an optimal predictor for the block in the list of predictors according to a given criterion. In step 400, it is checked if all blocks have been processed and a loop allows the progressive generation of the predictor map for all blocks.

If not all blocks have been processed, a current block to encode having an associated motion vector is considered.

For the current block to encode, the motion vectors corresponding to each type of predictor defined in the list are computed in step 401. Each computed motion vector is then compared to the actual motion vector of the current block, as computed by the encoder. In an embodiment, the following value is computed for each type of predictor of the list: Dᵢ=∥V_{p,i}−V_{b}∥ where V_{p,i} is the i^{th} computed motion vector and V_{b} is the actual motion vector of the current block, generally chosen by the encoder in order to minimize a rate-distortion criterion. Dᵢ is the L2 norm of the difference between the two vectors, which computes as a distance between two vectors the square root of the sum of the squared differences, component by component. The L1 norm, which computes as a distance between two vectors the sum of the absolute values of the differences, component by component, could also be used.

As already explained, some blocks to encode may be encoded using an INTRA coding mode, and thus may not have a motion vector associated by the encoding process. For such INTRA coded blocks, the median motion vector of the neighbouring blocks is used for example instead of V_{b} for calculating Dᵢ. Taking the example of FIG. 8, if block A is an INTRA encoded block, the median vector of the motion vectors for blocks B, C and D is used to determine the optimal type of predictor for block A.

The type of predictor able to provide the minimum distance, Dᵢ₀ of all the types of predictor of the list is selected. Its index i₀ is associated with the current block and is stored in the predictor map in step 402.

Once all the blocks have been processed, the predictor map is obtained by module 303. Each index of the map is associated with one block of the frame, making it possible to find the selected type of predictor for the associated block in the list of types of predictor.

As mentioned above, the predictor map is coded and transmitted to the client as additional information. In a first embodiment, the predictor map is compressed with a loss-less compression scheme. For example, a run length encoder is used.

However, in another embodiment represented in FIG. 4, an error correction code computation module 305 retrieves the predictor map in a step 403 and computes error correction codes in step 404. The Reed Solomon (RS) codes are used but other error correction codes could be used such as LDPC (low-density parity-check). An RS code can be defined by two values (n,k) where n is the number of symbols of a code word and k is the size of the information word.

A RS code is an error correction code which has the capacity of correcting (n−k)/2 errors. In an embodiment, the encoder determines the optimum code rate to protect efficiently the predictor map as a function of the error rate of the network. For example, if the video is a High Definition video coded with 10 slices (or NAL units) per frame, an image has a resolution of 1920×1088 pixels. If the block size is 16×16, each slice contains 816 blocks. RS code with k=8160 is thus used. A code rate R of 0.84 making it possible to obtain m=1672 parity symbols which represent a size of 209 bytes per frame can be used. With such code rate, the RS code efficiently corrects the predictor map when one slice is lost. Therefore, compact additional information which can help error correction in case of transmission losses can be sent.

Only the parity checks are sent to the decoder in step 405 in the additional information 310. The additional data stream has m/8 bytes per frame that is 209 bytes only in the described example. Module 305 thus encodes the predictor map as additional data and sends the encoded additional data. In the embodiment described above, the encoded additional data comprises information relative to each block of a frame. More generally the information of the additional data may be associated with only a subset of blocks of the frame.

FIG. 5 illustrates the additional information processing performed in the client.

The client 102 decodes the additional information with module 306. If the predictor map has been coded with a run-length coder then module 306 performs a run-length decoding algorithm to retrieve the predictor map. In another embodiment, the predictor map is coded with a Reed Solomon coder, and the module 306 first generates a partial predictor map, and then completes the predictor map with the help of the error correction code in steps 501, 502 and 503.

The generation of the predictor map is performed in steps 500, 504 and 505, similarly to the steps 400, 401 and 402 carried out at the encoder, for the blocks which have been correctly received. A prediction map, which may be incomplete in case of transmission errors, is obtained after all blocks of the current image to decode have been processed (answer ‘yes’ to test 500).

If an incomplete predictor map has been obtained, the additional data received can be used to fill the prediction map.

In the embodiment described as first embodiment with respect to FIG. 4, if the additional data which has been encoded without loss is correctly received, the additional data can be used straightforwardly to obtain a complete predictor map.

In the embodiment described as another embodiment with respect to FIG. 4, the additional data received contains the parity checks of the error correction codes computed for the predictor map.

In this embodiment, an incomplete predictor map is obtained in step 501, at the end of the loop of steps 500, 504 and 505.

The additional data associated with at least one block of the frame is used to correct the missing values of the incomplete predictor map. The error correction algorithm used with the RS parity checks is well known. If the code rate used by the server is sufficient, the whole predictor map can be completed. Information identifying one type of predictor in the predetermined list has thus been obtained using the additional data obtained at the end of steps 500, 504 and 505. The corrected predictor map is stored in step 503.

FIG. 6 shows the error concealment method of the invention. A set of motion vector candidates is computed for each erroneous block of the frame by various reconstruction methods (i.e. error concealment methods) in step 600 and then one of the vector candidates is selected in step 603, together with its associated reconstruction method.

Two major kinds of error concealment methods are known: spatial and temporal concealments. Spatial error concealment is based on the correction of lost pixels using valid pixels of the same frame. Temporal error concealment uses motion vectors of correctly decoded blocks to infer motion vectors of erroneous blocks.

In step 600 a set of motion vector candidates is determined using several temporal error concealments. Motion interpolation and motion extrapolation algorithms are used in an embodiment. In another embodiment, a greater number of reconstruction methods, in particular temporal algorithms, is used.

In FIG. 8, two consecutive frames of a video sequence are shown. The first frame 800 is correctly received and the second one 801 is erroneous. Due to packet loss the NAL unit 802 cannot be decoded. The concealment for the frame 801 with a temporal algorithm uses an estimation of motion vectors for the blocks of the erroneous area 802.

More precisely, if the reconstruction method is a motion interpolation algorithm, it uses the median vector of the motion vector of the closest valid blocks. For instance, the interpolated vector of block A is the median vector of the blocks B, C and D.

The motion extrapolation algorithm uses the motion vectors of the preceding frame and projects it in the current frame while assuming that the motion between the two frames is constant. The resulting motion vector field is assigned to the current frame. This defines a motion vector for each block of the lost area 802.

Two vector candidates are thus generated for each block of the area to be concealed in step 600. The first candidate is the motion interpolated vector and the second one is the motion extrapolated vector. The candidates are computed independently of the additional data.

In step 601, predicted information associated with each type of predictor of the list of types of predictor is computed. More precisely, predicted motion vectors of the current block associated with each type of predictor of the list of types of predictor are computed. This is done on the basis of the predefined types of predictor and on the basis of the motion vectors of the neighbouring blocks of the current block, but independently of the additional data.

The candidates are then compared with the predicted motion vectors. The norm of their difference is calculated with the equation below in step 602 where V_{p,i} is the i^{th} predictor and V_{c,j} is the j^{th} candidate: nd_{i,j}=∥V_{p,i}−V_{c,j}∥.

The index i₀ corresponding to the current block and indicating the type of predictor selected at the encoder is retrieved from the predictor map and one candidate is then selected on the basis of the following reasoning, using the information provided by i₀.

The predictor V_{p,i0} that has been selected by the server in step 401 is the closest to the original motion vector. Thus, the best candidate should also be closer to V_{p,i0} than to any other V_{p,i} predictor.

Consequently, in step 602 each candidate V_{c,j} that is closer to a predicted motion vector V_{p,i1} such that i₁ is different from i₀ is discarded. This is referred to as a preliminary assessment of the candidates. Then in step 603 three cases can be encountered.

In a first situation, all candidates have been discarded in step 602. In that case, all candidates seem false. Temporal error concealment is considered as not being adapted to correct the error and thus spatial error concealment is contemplated.

In a second situation, a single candidate is available at the end of step 602, and this candidate and its associated reconstruction method are selected in step 603.

In a third situation, several candidates are still available at the end of step 602. The candidates able to provide the minimum nd_{i0,j} value of all these remaining candidates is selected in step 603. The reconstruction method associated with that candidate, either motion interpolation or motion extrapolation in this example, is also selected.

The selected candidate, if any, is assigned to the current block and motion compensation is performed during step 604 in a temporal error concealment process.

If the error correction code rate is not well dimensioned or if additional information is lost during transmission, the predictor map may not be completely retrieved. In that case, the blocks for which no predictor index is defined are concealed with any method, for example a randomly chosen concealment method, or as an alternative a predetermined concealment method, for example the motion extrapolation algorithm.

In another embodiment, step 604 includes a sub-step of checking the final candidate, by comparing it with the predicted motion vector V_{p,i0} identified using the additional data to avoid using it if it seems inadequate. The norm of the difference of the two vectors is computed and compared to a pre-determined threshold. If the norm of the difference is above the threshold, the final candidate is discarded and spatial error concealment is applied. If the norm is below the threshold, the final candidate is used for temporal error concealment. This increases the quality of the displayed video sequence.

In an embodiment, only one temporal error concealment algorithm is used, for example motion extrapolation, and a step of comparing the norm of the difference with a threshold is also used. This allows the quality of the extrapolated vector to be assessed. If the vector is not validated by the step of comparing, then spatial error concealment is used in step 604. This enables the quality of the displayed sequence to be increased.

In a further embodiment, the index selected in module 303 of the server is determined with the following formula: D′ᵢ=∥V_{p,i}−V_{d}∥

in which V_{p,i} is the predicted motion vector corresponding to the i^{th} type of predictor of the list and V_{d} is the motion vector that allows minimization of the distortion (i.e. difference) between the reference block and the current block, and not, as in the previous embodiment, the motion vector V_{b} chosen by the encoder to minimize a rate-distortion criterion. For blocks coded with INTRA prediction, V_{d} is also the one that allows the distortion with the reference block to be minimized.

Steps 400, 401 and 402 of module 303 in this embodiment are identical to those of the previous embodiment with the exception that D′ᵢ, is used instead of Dᵢ.

In this embodiment, the client 102 may not able to retrieve the content of the predictor map since it may not be able to compute the vector V_{d}. However, the vectors V_{d} and V_{b} are generally almost identical and so are Dᵢ and D′ᵢ. The steps 500, 401 and 402 of the decoding module 306 are left unchanged. The code rate R of the error correction code is decreased at server 101 each time Dᵢ is significantly different from D′ᵢ. The correction capabilities of the client 102 are also increased. As a result, the decoding module 306 corrects false indexes in step 502.

Since the vector selected by the encoder for a block is the one that allows minimization of a rate-distortion criterion and not the one that allows minimization of the distortion between the reference block and the current block, the predicted motion vectors computed in step 601 are compared with a vector that is an adequate substitute for the motion vector that allows minimization of the distortion between the current block and the reference block but is not available to the server. The quality of the sequence to which concealment is applied is thus improved.

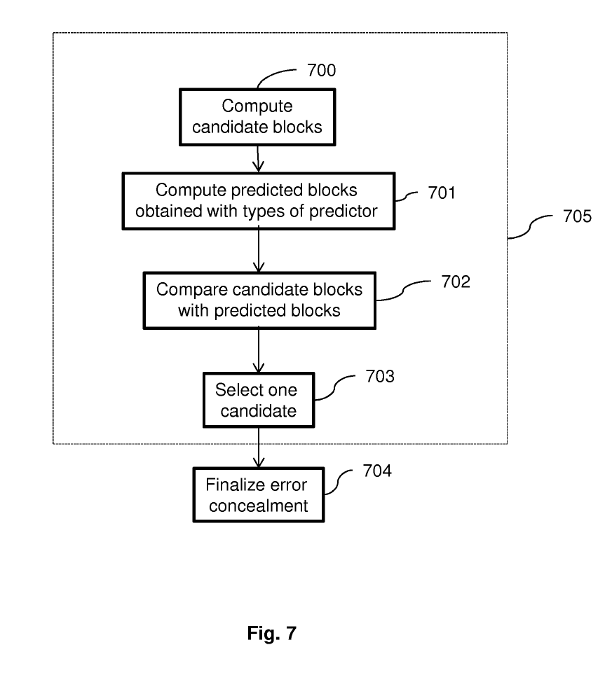

In still another embodiment depicted in FIG. 7, the list of types of predictor is composed of INTRA (spatial) and INTER (temporal) types of predictor (or block prediction schemes). For instance, two H.264 spatial types of predictor are included in the types of predictor list.

The selection of the type of predictor for the current block to encode, performed by module 401 (FIG. 4), includes the generation of predicted blocks for each type of predictor of the list. For example, a temporal predictor can be defined on the basis of the block of the reference frame pointed to by the motion vector of the co-located block of the current block to encode. It is referred to as the predicted block. For spatial types of predictor, the INTRA predicted blocks are generated.

The current block is then compared successively with each block associated with a type of predictor. The comparison method is the SAD (sum of absolute difference) between pixels of the two blocks.

The type of predictor selected by module 401 is the one that allows minimization of the SAD with the current block.

On the client's side, the selection of the reconstruction method performed in step 705 (FIG. 7) uses a generation of several blocks (step 700), named candidate blocks, with various reconstruction methods. These methods are either spatial or temporal concealment methods, or can be both spatial and temporal. Step 700 is performed independently of the additional data.

In step 701, predicted information for each type of predictor for the current block is computed. More precisely, each predicted block associated with a type of predictor of the list of types of predictor is computed. This is done on the basis of the predefined types of predictor, the neighbouring blocks of the current block and the preceding frame. This is done independently of the additional data.

Each candidate block is compared with the blocks obtained with the different types of predictor (step 702). This is referred to as a preliminary assessment of the candidates. Candidates that lead to a SAD value that is lower for a block obtained with a type of predictor different from the one identified by the predictor map than for the block obtained with the type of predictor identified by the predictor map are discarded.

The candidate among the remaining candidates, if any, that leads to the lowest SAD value with the block obtained with the type of predictor identified in the additional data is selected (step 703).

If all candidates have been discarded, the candidate among all the original candidates that leads to the lowest SAD with the block obtained with the type of predictor identified in the additional data is selected. The error concealment method associated with the selected candidate is then applied to the current frame (step 704).

The invention is not limited to the described embodiments, but covers all the variants within the capability of the person skilled in the art. While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A method of decoding a sequence of encoded digital frames encoded by an encoder using a format applying block-based prediction and, for the decoding of an encoded digital frame which comprises a missing area, the method comprising:
obtaining additional data associated with at least one block of the encoded digital frame;
obtaining, using the obtained additional data, for at least one block of the missing area, information identifying one type of predictor in a predetermined list of types of predictor; and
selecting a reconstruction method for the at least one block of the missing area using the information identifying one type of predictor.

2. The method according to claim 1, wherein selecting a reconstruction method for the at least one block of the missing area includes computing predicted information for at least one of the types of predictor of the predetermined list for the at least one block of the missing area independently of the obtained additional data and obtaining one item of predicted information using the identified one type of predictor.

3. The method according to claim 2, wherein computing predicted information includes computing a predicted motion vector.

4. The method according to claim 2, wherein computing predicted information includes computing a predicted block.

5. The method according to claim 1, wherein selecting a reconstruction method for the at least one block of the missing area includes computing at least one candidate for the at least one block of the missing area independently of the obtained additional data, wherein each of the at least one candidate is associated with a predefined reconstruction method.

6. The method according to claim 5 wherein selecting a reconstruction method for the at least one block of the missing area comprises selecting a candidate that is closer, according to a predetermined distance, to an item of predicted information computed for the at least one block of the missing area using the identified one type of predictor than to any other computed item of predicted information.

7. The method according to claim 1, wherein selecting a reconstruction method for the at least one block of the missing area includes computing a computed norm of a difference of one item of predicted information computed for the at least one block of the missing area and one candidate computed for the at least one block of the missing area, wherein the one candidate is associated with a predefined reconstruction method.

8. The method according to claim 7, wherein selecting a reconstruction method for the at least one block of the missing area further includes comparing the computed norm with a norm of a difference of one item of predicted information computed for the at least one block of the missing area using the identified one type of predictor and the one candidate.

9. The method according to claim 7, wherein selecting a reconstruction method for the at least one block of the missing area further includes comparing the computed norm with a predetermined threshold.

10. The method according to claim 1, wherein selecting a reconstruction method for the at least one block of the missing area includes selecting a reconstruction method associated with a particular candidate in a set of candidates in response to the particular candidate being an only candidate that has not been discarded during a preliminary assessment of all candidates of the set of candidates.

11. The method according to claim 1, wherein the obtained additional data comprises error correction information, and wherein obtaining information identifying one type of predictor in the predetermined list of types of predictor includes retrieving an index representative of the type of predictor by applying an error correction decoding using the obtained additional data.

12. A method of encoding a sequence of digital frames using a format applying block-based prediction and, for the encoding of a digital frame, the method comprising:
obtaining, for at least one block of the digital frame, information identifying one type of predictor in a predetermined list of types of predictor;
encoding the information identifying one type of predictor as encoded additional data; and
sending the encoded additional data over a network, wherein the encoded additional data is associated with the at least one block of the digital frame.

13. The method according to claim 12, wherein obtaining information identifying one type of predictor in the predetermined list of types of predictor includes comparing a predicted motion vector with a motion vector of the at least one block of the digital frame.

14. The method according to claim 12, wherein obtaining information identifying one type of predictor in the predetermined list of types of predictor includes comparing a predicted motion vector with a motion vector that allows minimization of distortion between a reference block and the at least one block of the digital frame.

15. The method according to claim 12, wherein obtaining information identifying one type of predictor in the predetermined list of types of predictor includes comparing a predicted block with the at least one block of the digital frame.

16. A device for decoding a sequence of encoded digital frames encoded by an encoder using a format applying block-based prediction and, for the decoding of an encoded digital frame which comprises a missing area, the device comprising:
an obtaining unit configured to obtain additional data associated with at least one block of the encoded digital frame;
an obtaining unit configured to obtain, using the obtained additional data, for at least one block of the missing area, information identifying one type of predictor in a predetermined list of types of predictor; and
a selecting unit configured to select a reconstruction method for the at least one block of the missing area using the information identifying one type of predictor.

17. A device for encoding a sequence of digital frames using a format applying block-based prediction and, for the encoding of a digital frame, the device comprising:
an obtaining unit configured to obtain, for at least one block of the digital frame, information identifying one type of predictor in a predetermined list of types of predictor;
an encoding unit configure to encode the information identifying one type of predictor as encoded additional data; and
a sending unit configured to send the encoded additional data over a network, wherein the encoded additional data is associated with the at least one block of the digital frame.

18. A non-transitory computer-readable storage medium storing a program that causes a device to perform the method according to claim 1.

19. A non-transitory computer-readable storage medium storing a program that causes a device to perform the method according to claim 12.
